(19) United States
(12) Patent Application Publication
(10) Pub. No.: US 2007/0283145 A1
(43) Pub. Date: Dec. 6, 2007

(54) Multi-Factor Security System With Portable Devices And Security Kernels

(76) Inventors: Carmi David Gressel, Mobile Post Negev (IL); Gabriel Vago, London (GB); Ran Granot, Yavne (IL); Torner Kanza, London (GB); Uzi Apple, London (GB); Avi Hecht, London (GB)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 11/578,929

(22) PCT Filed:
(86) PCT No.: PCT/IL05/00431

Related U.S. Application Data
(60) Provisional application No. 60/565,393, filed on Apr. 22, 2004.

(51) Int. Cl. G08B 29/00; H04L 9/32

(52) U.S. Cl. 713/164; 713/172

(57) ABSTRACT

A system for multi-factor security involving multiple secure devices that distribute the secured functions of the system over the different devices, such that the loss or theft of any one of them does not compromise the overall security of the system. Moreover, a configuration of devices is also secure even if one of them has been attacked by malicious software agents, such as “keyboard sniffers”. A novel contactless smart card reader (200) is presented that incorporates a transceiver antenna (220) within a keypad (210) of a device used with contactless smart cards (100). When the card (100) is pressed against the device's keypad (210), the transceiver (220) of the device establishes a session with the smart card (100). A variety of systems are presented, including those using mobile telephones, computer-interfaced card readers, personal digital appliances, and television set-top box remote controllers.

### FIELD OF THE INVENTION

The present invention relates to user security authentication, and, more particularly, to digital devices for activating computer startup and log-in, and controlled activation of cryptographic and other security processes.

### BACKGROUND OF THE INVENTION

Portable devices, such as mobile phones, set-top box controllers, secured memory controllers and Personal Digital Assistants (PDA's) have many of the attributes of smart cards as personal identifiers, with their implied promise of confidentiality of communicated and stored data. Users trust mobile phones, assuming that they are typically less prone than personal computers to viral attacks. Users also appreciate the reliability and the sensation of instantaneous system response to their keypad instructions. As a result of Wi-Fi, Bluetooth, and Internet access, the functional differences between such portable devices is becoming blurred.

Offsetting the advantages of portable devices, however, is the fact that such devices are prone to loss or theft, and with this hazard comes the risk that other individuals can thereby come into possession of the personal identification of the devices' owners, and assume those identities with fraudulent or criminal intent. Secure devices such as smart cards, mobile telephones, and the like are vulnerable to this hazard, and may not have enough inherent security to resist tampering attacks. Loses range from theft of telephone services to making purchases on the victim's account, and in many cases this is not detected in a timely manner. The Federal Trade Commission's (FTC) first national survey on identity theft reported that identity theft cost 3.3 million U.S. consumers $3.9 billion, and cost U.S. corporations $32 billion in one year.

The hazards of loss and theft expose users of portable devices, such as mobile telephones, personal digital appliances, pocket-sized data storage devices, and the like, to serious risk. The ease with which such devices can be lost or stolen, and the potential harm that can accrue because of loss or theft, places a great burden on the security measures that can be applied to such devices. Unfortunately, adequate cost-effective security to handle the risk is not available.

Current Limitations in Device Protection

Password protection is helpful, but is not sufficient to stop sophisticated attackers. There is thus a need for extended protection, especially where sensitive information is at stake.

Providing a computer solely with password protection for log-in generally assumes that attackers will not learn the password, and that unattended computers will not be compromised. A number of prior art devices have been proposed to overcome this vulnerability, among which are: portable, secured memory devices serving as personal identifiers. Devices of this sort include USB (Universal Serial Bus) devices interfaced to personal computers for emulating smart cards on a network. These are used for “safe” booting of computers and for encrypting data. Unfortunately, activation and/or access to these secured memory devices—and subsequently to computers whose log-in is guarded by these devices—typically depend once again on password identification, and suffer from many of the vulnerabilities of password protection. In addition, computers which are activated by smart cards are still subject to virus attacks, where log-in procedures and programs are corrupted, such as by Trojan Horse attacks, and other well-known attacks.

Furthermore, a computer is usually activated and controlled by the user's entering on a keyboard of a secret personal identification password or other confidential information. For increased security, this is sometimes augmented with additional options for biometric identification means, such as fingerprint, voiceprint, or retina identification. Computers in commercial environments typically host valuable data, which can be stolen or lost, when the computers are not attended, and are prone to attack from computer viruses and malicious software agents (such as keyboard “sniffers”) that record and compromise passwords as well as other sensitive data, evade protective software barriers and emulate normal usage to perform hostile procedures.

Through such ploys, attackers can “steal” the user's identity, and impersonate the user for fraudulent or criminal purposes.

Another weakness is that system administrators are usually entrusted with the ability to override individual user protection, thereby granting them access to virtually all content in a closed computer network. Even if this privilege is not abused, it opens up the possibility of additional attacks.

Biometric personal identification has been proposed as a way of overcoming the disadvantages of password validation. Unfortunately, however, biometric personal identification is costly and often liable to be compromised by an attack on the computer's procedures. Some popular biometric systems have high false rejection rates for whole classes of populations and races, e.g., finger print detection may be unreliable when used to identify elderly applicants and/or manual laborers. In a typical western world population, up to 3% of the potential users will be falsely rejected and accused of being imposters. In Far East applications, the rejection rate, typically, is higher. Some people have fingerprints which cannot be repeatedly recognized by any available fingerprint detection device. Generally, secret information is currently preferable to biometric identification, provided that such information can be shared in a secure microelectronic device.

There is thus a widely-recognized need for, and it would be highly advantageous to have, a system for increasing the security of portable devices, that would provide ease and convenience comparable to that of using improperly-secured or unsecured passwords, but with much stronger security, providing an immunity to malicious software agents, and assuring that the loss or theft of a protected device would not cause catastrophic loss to the user. This goal is met by the present invention.

### REFERENCES

Devices, apparatus and methods for integrating computing and communication systems with security devices are described in the following documents:
(a) U.S. Pat. No. 4,742,215 to Daughters, et al., for a smart card operating system, hereinafter denoted as “Daughters”.
(b) U.S. Pat. Nos. 5,664,017 and 5,852,665 to Gressel, et al., for data recovery, hereinafter denoted as “Gressel '017” and “Gressel '665”, respectively.
(c) U.S. Pat. No. 6,148,354 to Ban, et al., for a Universal Serial Bus flash-memory device architecture, hereinafter denoted as “Ban”.
(d) U.S. Pat. No. 6,360,321 to Gressel, et al., for cryptographically controlling a computing device via an external smart card reader, hereinafter denoted as “Gressel '321”.
(e) Philips Semiconductors—Identification—Mifare Classic Contactless Smart Card ICs, available on the Internet at www.semiconductors.philips.com/markets/identification/products/mifare/classic, Gratkorn, Austria, 2004, hereinafter denoted as “Mifare”.
(f) ISO 14443 Standard for Contactless Smart Card Interfacing.
(g) PGP User's Manual Version 8, “About Additional Decryption Keys”, 2003, for system administrators to recover encrypted data in files in a corporate system, hereinafter denoted as “PGP”.
(h) Miller, B., The 1995 Advanced Card and Technology Sourcebook, Warfel & Miller Inc., 1995, Sixth Edition, Page 24, hereinafter denoted as “Miller”.
(i) Lee, Jennifer, “Identity Theft Victimizes Millions, Costs Billions”, The New York Times, Sep. 9, 2003.
(j) Aladdin Knowledge System, “Aladdin eToken Authentication Device Integrated with Utimaco's SafeGuard PrivateDisk Solution”, hereinafter denoted as “Aladdin” www.aks.com/news/2004/etoken/authentication/device.asp, Feb. 16, 2004.
(k) Gressel, Carmi, “Outcanned, Decaffed Secured Java, The Case for ‘Old Fashioned’ Secured Kernels”, presentation at the RSA Conference 2003, Apr. 15, 2003.

### SUMMARY OF THE INVENTION

The present invention is of a system of secure devices which cooperate among themselves to achieve a higher degree of security in the validating of an authorized user than any single one of them could achieve, and which lessens the vulnerabilities inherent in any single device. In embodiments of the present invention, the devices interoperate among themselves to distribute their security functions, optimize their functionality, maintain high security, and minimize the impact of loss or theft of any single component. At the same time, embodiments of the present invention also present an easy-to-use system. This is particularly important, because a security system that is not easy and convenient is liable to remain unused. The term “validating” herein denotes the performing of a process by which the identity of a user or a device is verified to a high degree of certainty.

Thus, an objective of the present invention is to make an inexpensive yet effective security enhancement to the increasingly-popular and growing line of peripheral and portable electronic devices, by using a combination of simple low-cost devices, such that the loss or theft of any subset of these devices will not cause irreparable harm to the user, his clients, his employer, other rightful transactors, or owners of intellectual and other property.

A combination of several devices and/or procedures is referred to as a combination of “factors”. A password only security feature, for example, is a single-factor system. Embodiments of the present invention present two- and three-factor security systems, but principles of the present invention can be extended to include greater numbers of factors. The devices intercommunicate and authenticate one another, using well-known cryptographic protocols, such that each device provides an independent security factor. In an embodiment of the present invention, one of the devices is a smart card. In a preferred embodiment of the present invention, the smart card is a contactless smart card. The term “smart card” herein denotes any portable compact security device designed to be carried on one's person, including credit-card-like devices, smart tags, smart buttons, and the like, regardless of their particular shape or appearance.

In addition, embodiments of the present invention reduce the risk of security compromise due to malicious software agents (such as “keyboard sniffers” on computers) by employing independent, secure keypads and similar input devices, and by using processors with security kernels. Trusted security kernels are well-known in the art, and provide for secure tamper-resistant control of memory in any location, whether internal or external to the security kernel. An essential property of a trusted security kernel is that the contents typically cannot be changed through unauthorized means. Thus, a security kernel can manage financial transactions, digital rights management, control of electronic debiting, monetary purses, and other sensitive applications in a dependable fashion.

In an embodiment of the present invention, biometric attributes are input directly into a security kernel for processing, thereby avoiding the risk of leaking confidential data into an insecure environment. Secure device configurations, such as those demonstrated herein, are equipped with an analog input from a biometric sensor to the security kernel, wherein comparison to and updating of identity templates and personal data are controlled and stored, and are more robust than configurations involving direct input into an ordinary computer.

“Intellifiers”

The term “Intellifier” herein denotes an “intelligent identifier”, which is any secure device or system capable of providing high-confidence identification for a user, through the application of cryptographic techniques and protocols. In particular, an intellifier can present an authenticated certificate which can be validated by use of a widely-known public key belonging to a trusted certification authority for identifying a user, and thereby can supply an abstract of the user's personal information. Intellifiers according to embodiments of the present invention are devices as described in FIGS. 1 through 7, or combinations thereof.

An embodiment of the present invention provides for a portable device keypad for answering random queries that cannot be predicted by an attacker. As a non-limiting example, such random queries can include multiple-choice questions answered by the user via a secure keypad. In a secure environment, a procedure can be enacted via a network with a trusted third party, and would be useful as an alternative to a smart card, or when the smart card is missing or faulty.

Using a smart card (or equivalent device) for final confirmation, during a transaction, of the transacting party's personal identity via a digital signature assures a reasonable level of confidence that the transaction was not initiated by an imposter on an unattended computer by an intruder using a stolen identification device. Embodiments of the present invention enable such identification through a tamper-resistant device and corresponding operational platform on a computer. Embedded memory in mobile phones and secure memory in portable memory devices are less vulnerable to attack when they are activated only by portable identifiers (such as smart cards), and when content is downloaded and stored in memory protected by immutable firmware.

Another objective of the present invention is to add simple inexpensive protection to popular security devices, to combat identify theft. Simple password login (“single-factor” identification) on an unsecured computer can be replaced by secured external boot single-factor password login identification. A combination of “two-factor” security for personal identification, where both factors are secured, replaces a password activating an unsecured procedure or a secured device on the computer. In some implementations, often at no additional cost, a secured identification can be extended to three or more factors. As a non-limiting example, authorization can be based on a secret that the user knows combined with secret data known only to the portable device (e.g., smart card), along with data known only to the device external to the computer. These devices can confirm to one another through cryptographic protocols that they have the secret data (without revealing the data itself), and can thus work together to provide enhanced security for the computer.

As noted previously, system administrators are usually given the ability to override individual user protection. Another one of the objectives of the present invention is thus to oblige network administrators to be more responsible for their intrusions. Over-riding procedures can be limited, regulated and archived when the activation of such procedures is through a security kernel peripheral, activated by the system administrator's smart card and information known only to the system administrator. Thus, actions of the system administrator can be archived and abstracts of those actions maintained in the smart card and in the Intellifier. In an embodiment of the present invention, administrators' certificates control and/or limit access and activities during specified time intervals.

It is also an objective of the present invention to configure these devices in such a way as to minimize their potential vulnerability to attack. As a non-limiting example, in an embodiment of the present invention, a portable controlling device has an integrated keyboard that is immune to the kind of intrusion to which a computer might the be vulnerable. As another non-limiting example, a portable computer could securely store a set of unique user-specified queries which only the user or a designated operator would be able to answer. The second strategy, query and keypad response, is typically a backup for the first hardware dependent operation in the absence or loss of the personal identifying device. This resembles current two-factor identity schemes, except that the whole process is executed in a secured environment in a microelectronic kernel.

Still another objective of the present invention is to activate a portable device typically capable of performing transactions and storing encrypted data in unprotected media, e.g., on commercial servers or local hard disks, with the knowledge that such data can be recovered and returned to the rightful owner, after due process, in the event of failure or loss of the access control and/or encryption devices, and, further a reputable manufacturer can be entitled to reconstruct the devices which were lost, faulty, or destroyed. Methods for data recovery and “undeniable” archiving are found in Gressel '017 and Gressel '665.

A further objective of the present invention is to grant added value to both the supplier and the user of a proprietary program, as an incentive to the user to obtain the regular commercial version of the program rather than one in pirated form, where the security has been compromised and where the product is thus vulnerable to viruses, keyboard sniffers and the like. Consumers are usually willing to pay for a memory device, mobile phone, or similar device with such advantages to both the product vendors and the users.

Yet another objective of the present invention is to attain the advantages of interchangeability for these devices and procedures, and/or the ability to improve security by using a combination of devices. As a non-limiting example, using either the secured memory controller or the mobile telephone can establish a secured link with a third party, capable of public and symmetric cryptography in one of the following modes:
(a) where a receiving device (such as the memory controller or the telephone) emulates a smart card;
(b) where a receiving device serves as a terminal and the smart card establishes the identity of the user;
(c) where a receiving device, after initialization, serves both as a terminal device to a plurality of users, and emulates the principal initializing user.

The present invention discloses the use of portable identification devices, and shows a novel method for using smart cards to protect access to computers, portable devices and secured procedures. Similar wireless identifiers (with or without self-contained power supplies, such as RF tags, and the like) are included in the scope of the present invention. Likewise, systems using conventional smart cards communicating via integrated conventional smart card acceptors (without a wireless transceiver) have equivalent attributes to those disclosed herein and are also included within the scope of the present invention. As a non-limiting example, holding a contactless smart card close to a transmit/receive antenna is functionally equivalent to inserting a contact smart card into a smart card acceptor—inserting a smart card into a smart card acceptor activates a miniature switch and initiates a wired communication session; bringing a contactless smart card into proximity of a compatible transceiver likewise initiates a radio communication session even though there may be no physical contact.

Embodiments of the present invention focus on three popular devices: the mobile telephone phone; the portable memory device; and the remote set-top box controller. These devices—by virtue of their small size, sophisticated digital capabilities, and portability—already possess many advantages for use as personal identifiers, but they are vulnerable to loss or theft. An attacker who comes into possession of one of these devices may be easily able to assume the identity of the owner. By providing such devices with interoperating validation protocols, their overall security is greatly enhanced. The present invention is thus applicable to PDA's and other digital devices in a like manner.

Contactless Smart Cards

Contactless smart cards and similar wireless devices are growing in importance as remote access controllers, communicating via terminal reader/writers that can read and verify the contents of the device, which for some readers can be up to 100 centimeters away. In most applications, there is a clear advantage in not having to bring the device in contact with the reader—the device, for example, can remain in a user's wallet or be attached to a box on a conveyor belt. The disadvantage, however, is the cost in energy and hardware complexity, which in some applications puts limits on computational capability and data transmission speed. Close-proximity identification demands less energy and smaller antennae, comparable to the limited current available to drive the antenna on common USB devices. The term “contactless smart card” herein denotes a smart card which is capable of communication with another device without requiring physical contact between them, such as by radio frequency transmission. It is noted that some contactless smart cards also possess exterior hardware contacts. Thus, the term “contactless smart card” does not imply that the smart card lacks contacts, but rather that the smart card does not require contact for operation.

In a preferred embodiment of the present invention a portable contactless device, such as a smart card, is brought in close proximity with a small antenna embedded in a plastic keypad which is activated only when the user presses the contactless device against the keypad, or when the user is requested to place the contactless device in close proximity with the antenna of the communicating device. In a computing environment, this can initiate login. In preferred embodiments of the present invention, the user activates the smart card via a secure keypad.

Many contactless smart cards also have contact capability for increased speed and popular acceptance. Such a smart card is able to perform both the normal contactless tasks, and, when in contact mode, the more computationally-difficult tasks, which require higher speed and increased energy, e.g., downloading software upgrades, refurbishing an electronic purse, or other secure financial transactions.

Where low power consumption is a requirement (such as with battery-operated lap-top personal computers), the secure memory device is actuated by pressing the contactless smart card directly against the keypad, activating the transceiver antenna and thereby initiating an identifying session. This procedure can be in addition to a normal password login. All procedures using wireless devices, as detailed herein pertain to methods and apparatus wherein communication is accomplished via wires, optical fiber communication devices, and other equivalent means.

It will be appreciated that a system according to the present invention may be a suitably-programmed computer, and that a method of the present invention may be performed by a suitably-programmed computer, including the processor of a smart card or similar device. Thus, the invention contemplates a computer program that is readable by a computer for emulating or effecting a system of the invention, or any part thereof, or for executing a method of the invention, or any part thereof. The term “computer program” herein denotes any collection of machine-readable codes, and/or instructions, and/or data residing in a machine-readable memory or in machine-readable storage, and executable by a machine for emulating or effecting a system of the invention or any part thereof, or for performing a method of the invention or any part thereof.

Therefore, according to the present invention there is provided a system for multi-factor security including a plurality of secure devices which intercommunicate and validate one another, wherein each of the plurality of devices provides an independent security factor for validating a user.

### BRIEF DESCRIPTION OF THE DRAWINGS

The invention is herein described, by way of example only, with reference to the accompanying drawings, wherein:

FIG. 1A is a conceptual diagram of a prior art computer peripheral device (a removable mass storage device).

FIG. 1B is a conceptual diagram of a removable mass storage computer peripheral device according to an embodiment of the present invention, coupled to a secure keypad and activating a contactless smart card.

FIG. 2 illustrates a multi-factor system according to an embodiment of the present invention, using a personal computer, an intellifier, and a smart card.

FIG. 3 depicts a user pressing a contactless smart card against the keypad of a peripheral device as in FIG. 2, to initiate and enable procedures.

FIG. 4 is conceptually illustrates a mobile telephone with an antenna in the keypad, for communicating with a contactless smart card.

FIG. 5 is a conceptual illustration of using a contactless smart card to complete a purchase, the value of which the user approves for payment upon reading the LCD display of the mobile phone of FIG. 4.

FIG. 6 is a conceptual illustration showing the use of a remote television set-top box controller with an embedded contactless smart card reader, for making commitments to vendors and service providers.

FIG. 7 illustrates a multi-factor system according to an embodiment of the present invention, using a personal computer, an intellifier connected via a cable, and a smart card.

FIG. 8 illustrates a printed circuit board for a keypad having an integral antenna for a contactless smart card, according to an embodiment of the present invention.

### DETAILED DESCRIPTION OF THE PREFERRED EMBODIMENTS

The principles and operation of a method and apparatus according to the present invention may be understood with reference to the drawings and the accompanying description.

In the following embodiments of the present invention, a contactless smart card is used in combination with one or more other devices to allow mutual authentication among them.

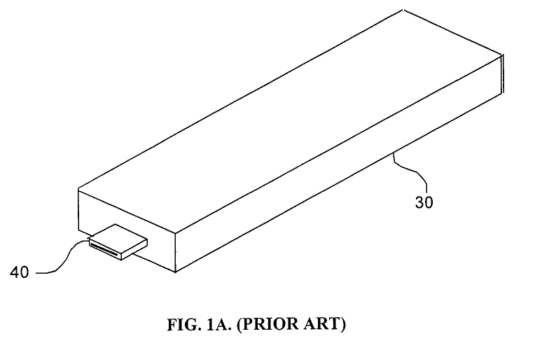

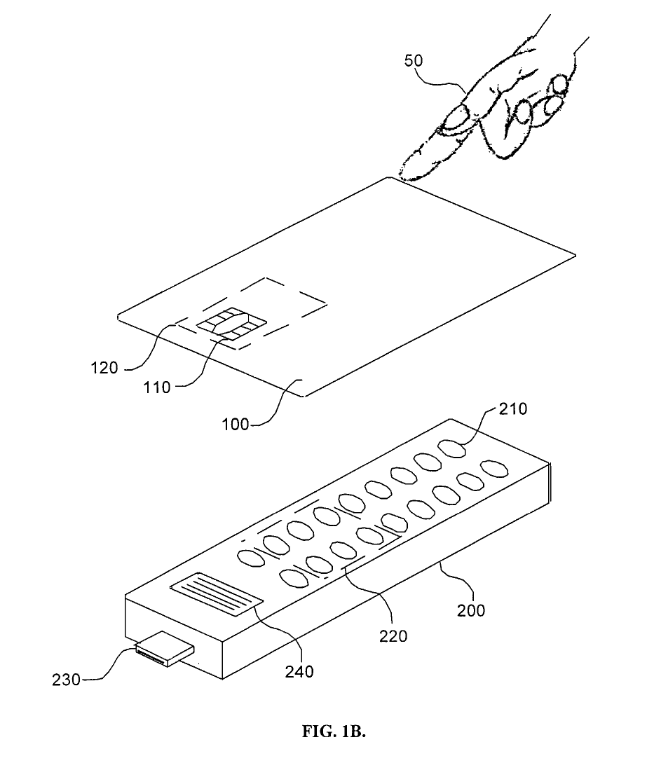

FIG. 1A is a conceptual diagram of a prior-art computer peripheral device 30 (a mass storage device) with an interface connector 40. FIG. 1B is a conceptual diagram of such a device 200 according to an embodiment of the present invention, wherein device 200 is coupled to a contactless smart card 100 belonging to a user 50. On device 200 is a keypad 210 which communicates directly with an internal secure processor within device 200, without revealing keypad action to the external host computer. Within keypad 210 is an antenna 220 and a transceiver (not shown) for communicating with smart card 100. A connector 230 enables device 200 to interface to a computer. Suitable connectors for use as connector 230 include, but are not limited to USB connectors, PCMCIA connectors, other serial connectors, and parallel connectors. Because keypad 210 communicates directly with the internal secure processor of device 200, there is substantially no risk of security compromise from malicious software agents (such as “keyboard sniffers”). Smart card 100 has an embedded antenna 120 for contactless operation, but also has standard ISO 7915 contacts 110 for hardware contact operation as well.

According to embodiments of the present invention, user 50 initiates multi-factor secure operations by pressing smart card 100 against keypad 210 of device 200. This action accomplishes several goals. First, it is relatively easy for user 50 to perform such an action. Because smart card 100 is contactless, user 50 does not need to perform any kind of precise alignment, such as inserting smart card 100 into a reader slot. Smart card 100 can be pressed against keypad 210 at an angle, upside down, and/or off-center. Not having to perform a precise alignment improves the convenience and speed with which user 50 can perform the action, and reduces frustration and bother. Second, pressing smart card 100 against keypad 210 allows device 200 to power-up the internal transceiver to initiate a session only when smart card 100 is in proximity, thereby saving power. Third, the close position of smart card 100 and device 200 minimizes the RF power required to energize smart card 100 for the intensive processing needed for certain cryptographic operations.

To facilitate enabling user 50 to confirm what has been negotiated and to know in advance what the commitment is, prior to pressing smart card 100 onto keypad 210 for final confirmation, device 200 nominally includes a liquid crystal display 240 for notifying user 50.

As is well-known in the art, smart card 100 typically has a secure microcontroller or finite state machine for identifying device 200, using prior art public key cryptographic, and symmetric cryptographic message authentication cryptographic methods and/or codes. The smart card accepts or rejects user 50, according to entered passwords or other information, typically transmitted to smart card 100 in encrypted form and readable only by smart card 100. Such acceptance or rejection as well as and normally all other transmitted data between smart card 100 and device 200 is encoded such that an attacker who intercepts the radio frequency messaging between smart card 100 and peripheral device 200 typically receives substantially unintelligible data.

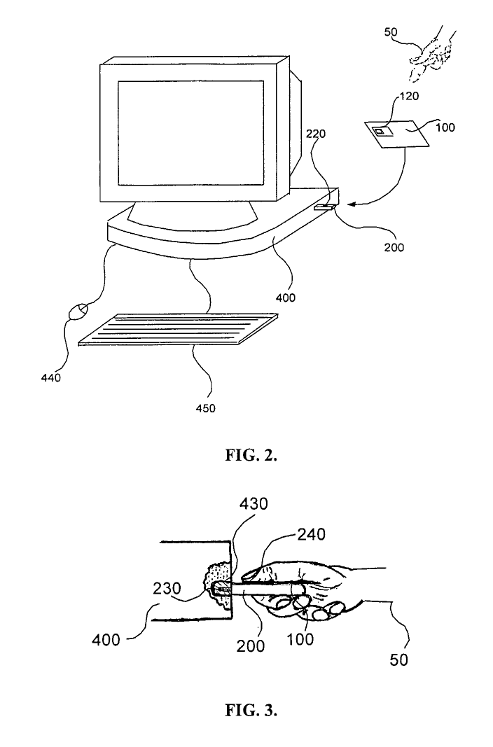

FIG. 2 shows a configuration of a computer 400 with the two devices of FIG. 1 to enable activation either from contactless smart card 100, from keypad 210 (FIG. 1) on device 200, or in combinations thereof for one, two, three, or higher multi-factor secure identification. Computer 400 has a keyboard 450 and a mouse (or similar pointing device) 440, as well as a port 430 for interfacing with device 200. A display 460 provides user queries, instructions, and information.

Device 200 typically includes a battery backup, to support a real-time clock and to enable user 50 to activate circuitry in device 200 prior to connecting to computer 400.

The operating system of computer 400 is configured to terminate a session with smart card 100 and to decline commands from keyboard 450 or mouse 440 after a predetermined time interval has passed during which no input has been received from keyboard 450 or from mouse 440. In case of such termination, user 50 can, reapply smart card 100 to device 200 to reinitiate a session. If a steady source of electrical power is available such that power is not at a premium, antenna 220 typically radiates signals continuously to sense the proximity of smart card 100. Where there are energy restrictions, however, (such as under limited battery power), smart card 100 must be pressed against keypad 210, as previously noted, to conserve power.

FIG. 3 shows user 50 pressing contactless smart card 100 against the keypad of device 200, whose connector 230 is plugged into computer 400 in order to initiate and enable procedures. Display 240 gives user queries, instructions, and information.

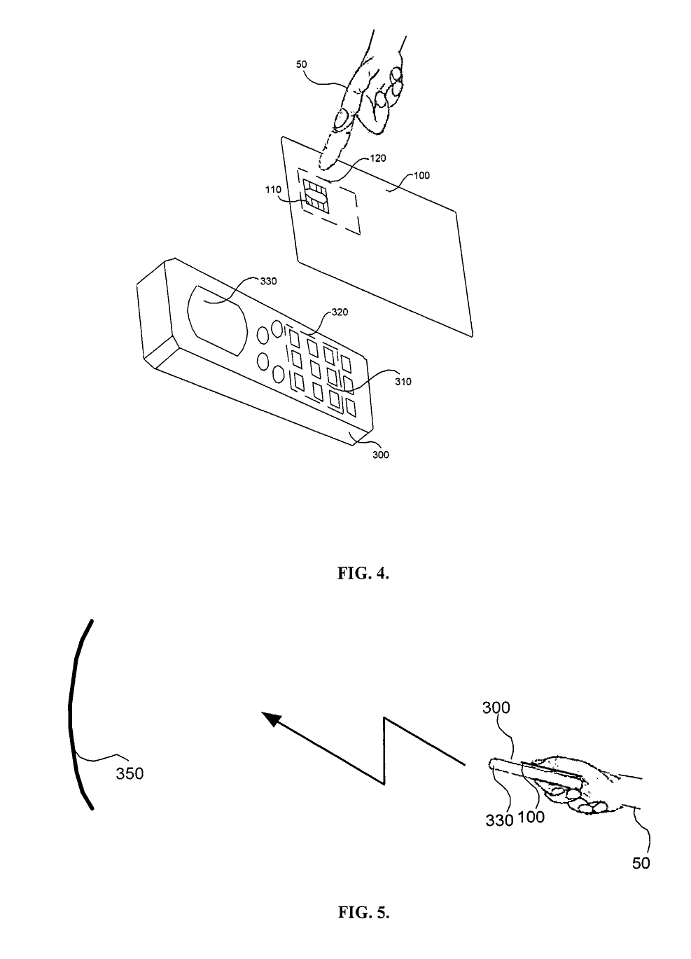

FIG. 4 conceptually illustrates a mobile telephone 300 having a keypad 310, with an embedded antenna 320, for communicating with contactless smart card 100 via embedded antenna 120. This configuration enables user 50 to make a commitment via, or to, mobile telephone 300, which may also serve as a commercial smart card terminal connecting to a local establishment, via conventional infra-red, Bluetooth, or radio frequency, such as to a remote clearing house for credit and debit card transactions. A display 330 gives user queries, instructions, and information. FIG. 5 shows user 50 holding mobile telephone 300 while pressing smart card 100 against the keypad to establish a link with a communicating device or system 350.

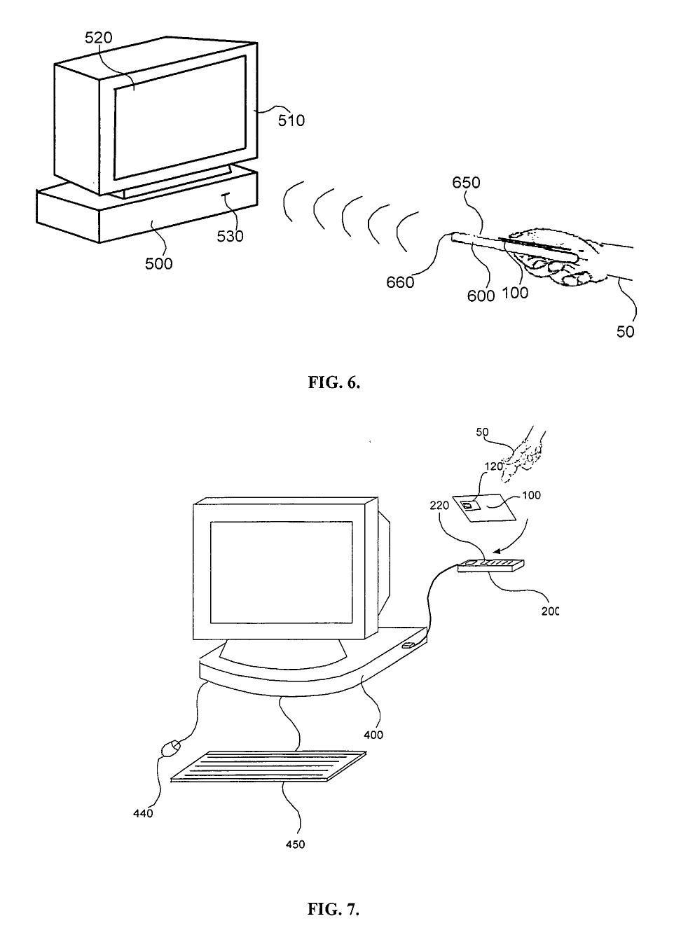

FIG. 6 conceptually illustrates user 50 employing a remote television set-top box controller 600, having a keypad 650 with embedded antenna (not shown, but similar to antenna 320 of FIG. 4) and a wireless transmitter 660, which transmits signals to a wireless receiver 530 of a set-top box controller 500 connected to a television receiver 510 and to an external communication system (not shown) via cable, telephone line, or satellite dish. Wireless communication is often effected via infrared links, but is not limited to infrared technology. Controller 600 is generally a transmit-only device and therefore lacks an integral display. Instead, display of user queries, instructions, and information is done via a television screen 520. similar to a mobile phone with an embedded contactless smart card reader, operative to make personalized commitments via the settop box to a variety of vendors and service providers. User 50 presses smart card 100 against keypad 650 to initiate a secure confirmation of a transaction, or perform some other authenticated procedure. In other embodiments of the present invention, a device can also have a wireless receiver.

FIG. 7 illustrates a configuration similar to that of FIG. 2, except that device 200 is connected via a cable 250 for remote use and for less restricted use as a smart card reader, and to facilitate the confidential use of keypad 220 and display 240.

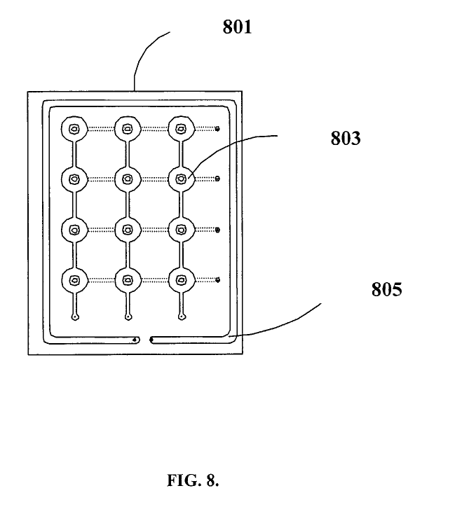

FIG. 8 illustrates a printed circuit board 801 for a typical device keypad, having a keypad matrix 803 (in this non-limiting example being a simple 4×3 row-column matrix) around which is printed a multi-loop antenna 805 (not clear that is many loops in FIG. 8). Printing the loop antenna on the keypad circuit board incurs substantially no additional cost. In FIG. 8 antenna 805 is shown as a single loop for clarity, but embodiments of the present invention multiple loops feature multi-loop antennas.

Properties

Included in the devices described above are tamper-resistant digital means for the device owner to prove his identity to a trusted certification authority. In preferred embodiments of the present invention this would be via a security kernel, as previously mentioned. Here, the certification authority's identity is immutable, and the user's secret information is stored in memory by frozen, immutable protocol. In such preferred embodiments, the personal identifier complies with financial industry security standards, enabling the user to interactively make purchases over the Internet, or via interactive television.

Strategy

In embodiments of the present invention as presented above, the strategy is to combine a number of secure devices in such a way that the loss or theft of any single one of them would not expose the owner to the hazards of unauthorized use of the device and identity theft. For example, if smart card 100 were intended to be used in conjunction with device 200 (FIG. 2), and were smart card 100 to be stolen while being carried on the owner's person, the thief would be unable to initiate any transactions in impersonation of the owner, because he would normally not have access to device 200. Thus, this “two-factor” security would prevent any further harm to the owner. By adding password protection to the system, a third factor is introduced, further increasing the level of security. Moreover, by adding cryptographic to computer 400 a fourth factor is introduced, yet again increasing the level of security.

Passwords and Other Software-Based Security Factors

Passwords are well known in the art, and can be used as an additional security factor, as described above. Passwords, however, suffer from the limitation that the user can easily forget a critical password. Furthermore, under normal circumstances, a password may be compromised by an attacker in various ways. In addition to, or in place of passwords, therefore, the increased memory capabilities of the devices presented above permit more extensive information related to the user to be stored and used as an additional security factor. In an embodiment of the present invention, a device (such as device 200) stores a database of personal information about the user that other individuals would be unlikely to know. As a non-limiting example, the database may contain the user's mother's maiden name, the name of the high school attended by the user, his place of birth, the name of his pet, and so forth. To use this identification method, device 200 would display a question on display 220 along with several possible numbered answers. To respond, the user would enter the number of the correct answer on keypad 210. This is a secure way of handling the input of the answer, because keypad input into device 200 is direct into the security kernel of the processor in device 200. To increase the confidence that the authorized user has input the answer, and that it was not just a lucky guess by a finder, a series of such questions can be posed. In the configuration as shown in FIG. 2 or FIG. 7, the questions can be displayed on computer monitor screen 460. As before, however, the answer is still input via keypad 210. It is possibly insecure to input the answer to the question via keyboard 450, because of the risk of malicious software agents, such as “keyboard sniffers” which may have been surreptitiously installed in computer 400. By inputting the answer into keypad 210, however, the answer cannot be compromised by such agents. In other words, computer 400 can display the question without risk of compromise, but never comes into contact with the answer.

While the invention has been described with respect to a limited number of embodiments, it will be appreciated that many variations, modifications and other applications of the invention may be made.

1-15. (canceled)

16. A wireless cryptographic communication system comprising:
a pair of wireless communication devices each having cryptographic identification functionality, including:
a first wireless communication device having a smart-card-only mode of operation comprising only a smart card functionality, said smart-card-only mode of operation being operative upon receipt of an electromagnetic actuation signal, and
a second wireless communication device in electromagnetic communication with the first wireless communication device which radiates electromagnetic energy only in response to physical activation thereof by a user.

17. A system according to claim 16 wherein said first wireless communication device is a smart card.

18. A system according to claim 16 wherein said physical activation responsive to which the second wireless communication device radiates energy comprises a designated mechanical manipulation of the second wireless communication device by a user.

19. A system according to claim 16 wherein at least one of said wireless communication devices comprises one of the following:
a computer peripheral with a security kernel;
a mobile telephone;
a mass storage device;
a remote set-top box controller; and
a personal digital appliance.

20. A system according to claim 16 wherein said second wireless communication device comprises:
a keypad;
a surface bearing said keypad; and
an antenna, communicating with said first wireless communication device, disposed on said surface.

21. A system according to claim 16 wherein said second wireless communication device comprises a secured keypad.

22. A system according to claim 16 wherein said second wireless communication device comprises a non-volatile secured memory operative to store at least one system secret protected by an on-board security kernel.

23. A system according to claim 22 wherein said at least one system secret includes at least one of the following group: a secret algorithm, a secret key, and a personal identifying data element.

24. A system according to claim 16 wherein said second wireless communication device comprises an internal tamper-resistant keypad connected to an on-board security kernel.

25. A system according to claim 16 wherein said second wireless communication device comprises a display for validated images which is controllable by an on-board security kernel.

26. A system according to claim 16 wherein said second wireless communication device comprises an enhanced security kernel module including at least one cryptographic device for identifying operators of said plurality of intellifiers.

27. A system according to claim 16 wherein said second wireless communication device comprises a secured biometric data validation algorithm and secured memory including an on-board security kernel serving the biometric data validation algorithm.

28. A system according to claim 16 wherein at least one of said wireless communication devices is tamper-resistant.

29. A wireless cryptographic communication method comprising:
providing a pair of wireless communication devices each having cryptographic identification functionality, including a first wireless communication device having a smart-card-only mode of operation comprising only a smart card functionality, said smart-card-only mode of operation becoming operative upon receipt of an electromagnetic actuation signal, and a second wireless communication device in electromagnetic communication with the first wireless communication device which first device radiates electromagnetic energy only in response to physical activation of the first device by a user.

30. A method according to claim 29 and also comprising physically activating said second wireless communication device.
